(19) United States
(12) Patent Application Publication
(10) Pub. No.: US 2010/0176574 A1
(43) Pub. Date: Jul. 15, 2010

(54) Golf Chariot fot individual transport on a golf course

(75) Inventor: Ferdinando Pollice, Milano (IT)

Correspondence Address: Ferdinando Pollice, Viale Abruzzi 46, Milano, 20131, IT

(73) Assignee: Ferdinando Pollice, Milano (IT)

(21) Appl. No.: 12/652,160

(22) Filed: Jan. 5, 2010

(30) Foreign Application Priority Data
Jan. 31, 2008 (IT) MI2008U000038

(51) Int. Cl. B62D 63/00; B62B 3/02

(52) U.S. Cl. 280/401; 280/656

(57) ABSTRACT

The proposed invention is intended to provide Golf players with an easy to use, effective and economical solution that allow the player to decide at any time during the game, whether to walk or to ride; this flexibility is the main value of this idea.

Basically the idea is to add a wheeled platform to an electric golf cart enabled to steer by varying the power to the wheel; the result will be a sort of modern “chariot ”: a two-wheeled platform drawn by an electric golf cart.

The player will be able to ride on the platform or to walk as usual, accordingly with his/her wish. The platform can be lifted at any time with just one hand.

### CROSS REFERENCE TO RELATED APPLICATIONS

MI2008U000038, Italy, Jan. 31, 2008, Is exactly the same

### STATEMENT REGARDING FEDERALLY SPONSORED RESEARCH OR DEVELOPMENT

Not Applicable

### REFERENCE TO SEQUENCE LISTING OR COMPUTER PROGRAM LISTING

Not Applicable

### BACKGROUND OF THE INVENTION

This invention is related to the Golf game environment and more specifically to golf cart and also to individual transport on a golf course.

Nowadays a golfer has, usually, only two options: either ride on a golf car (or bike) or walk behind a golf cart (electric or manual).

My invention wants to provide a non-expensive alternative that allow a player to ride or walk accordingly with his/her wish at any time during a round of golf.

There are, to my knowledge, other patents aiming to solve the same needs, however I do believe no one has the economics, the simplicity and yet the effectiveness to break the market.

### BRIEF SUMMARY OF THE INVENTION

The proposed invention is intended to provide Golf players with an easy to use, effective and economical solution that allow the player to decide at any time during the game, whether to walk or to ride.

Basically the idea is to add a wheeled platform to a properly equipped electric golf cart, the result will be a sort of modern “chariot ”: a two-wheeled platform drawn by an electric golf cart.

The player will be able to ride on the platform (FIG. 1) or to walk as usual, accordingly with his/her wish. The platform can be lifted at any time with just one hand (FIG. 2).

The exemplary embodiment of the present invention is just one possible solution.

The idea will solve the requirements of those golfer who do like to walk but, from time to time, or for longer transfer, would like to have a faster and comfortable way of moving.

I'm aware that there are other solutions but, to my knowledge there is nothing available with the following characteristics:

Extremely easy to build and cost effective

Very stable solution with 2 additional wheel and a solid platform

Space saving because, when the platform is lifted (closed) (FIG. 2), the cart require no more room than a standard one thus allowing the Golf Clubs to store the cart in the same room of the standard electric cart, with no additional cost=space.

Today there are several model of golf cart in the market and the requirements for the golf cart I'll mention, one by one, are already available in one model or another, therefore I'll not cover in details those features.

### BRIEF DESCRIPTION OF THE SEVERAL VIEWS OF THE DRAWING

FIG. 1 is an functional view of the Golf Chariot when the golfer is riding it. It's clear that there an electric golf cart in front and a platform behind that allow the golfer to ride in a standing position.

FIG. 2 is a functional view of the Golf Chariot when the golfer is either walking behind or resting. The platform is resting in upright position.

FIG. 3 is a detailed side view of the Golf Chariot assembled components

FIG. 4 is an elevational view of the assembled components with evidence of the rotational capability of the platform.

FIG. 5 is a side view of the platform frame

FIG. 6 is an elevational view of the platform frame

FIG. 7 is a side view of the hook to be added at the rear bottom of the electric cart to allow the coupling with the platform.

FIG. 8 is a sectional view of the holes on the side of the front arms of the platform frame trough which the bolt will be hinged to the front section of the frame. This will allow the platform to rotate on a vertical plane and to be put in a resting position.

FIG. 9 is a sectional view of the hole in the front midsection of the frame that allow the coupling trough the hook at the bottom end of the cart.

### DETAILED DESCRIPTION OF THE INVENTION

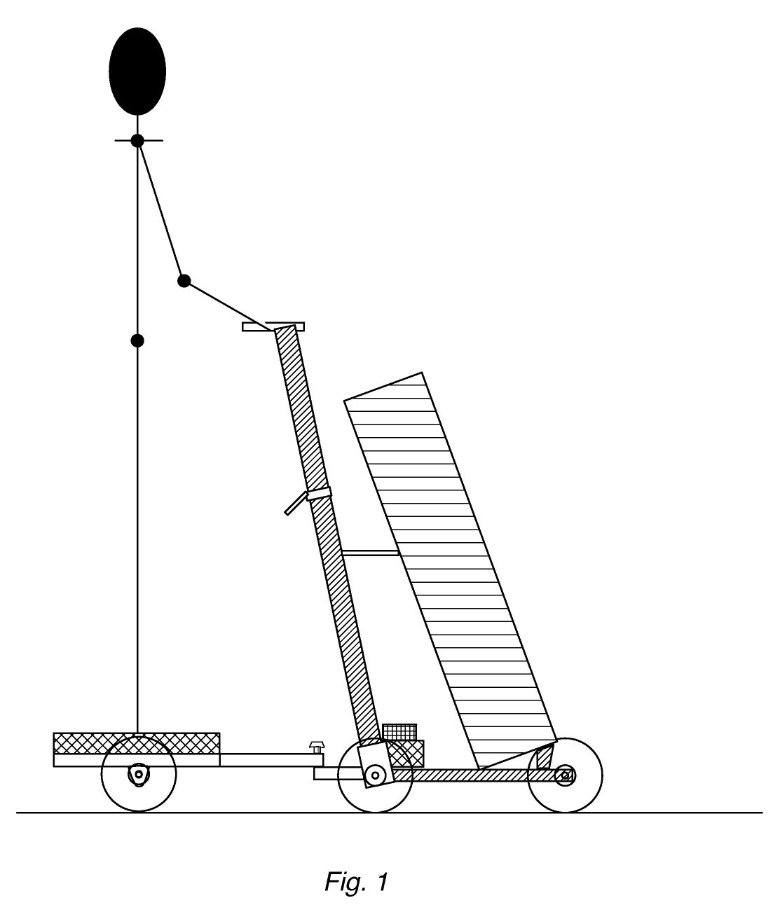

The present invention consist in coupling a wheeled platform to a properly equipped golf electric cart in order to build a golf chariot for individual transport on a golf course as for FIG. 1. The platform 2 is connected to the electric Golf cart with a hook 6 at the rear end of the cart, that is plugged in the front section 4 hole 25 (FIG. 7) and locked with a nut 7.

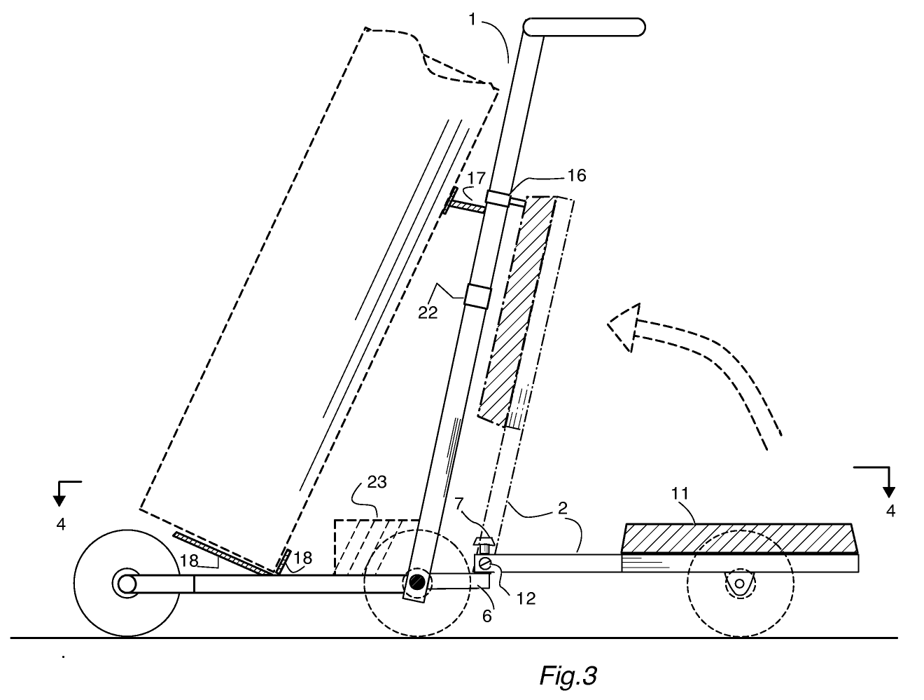

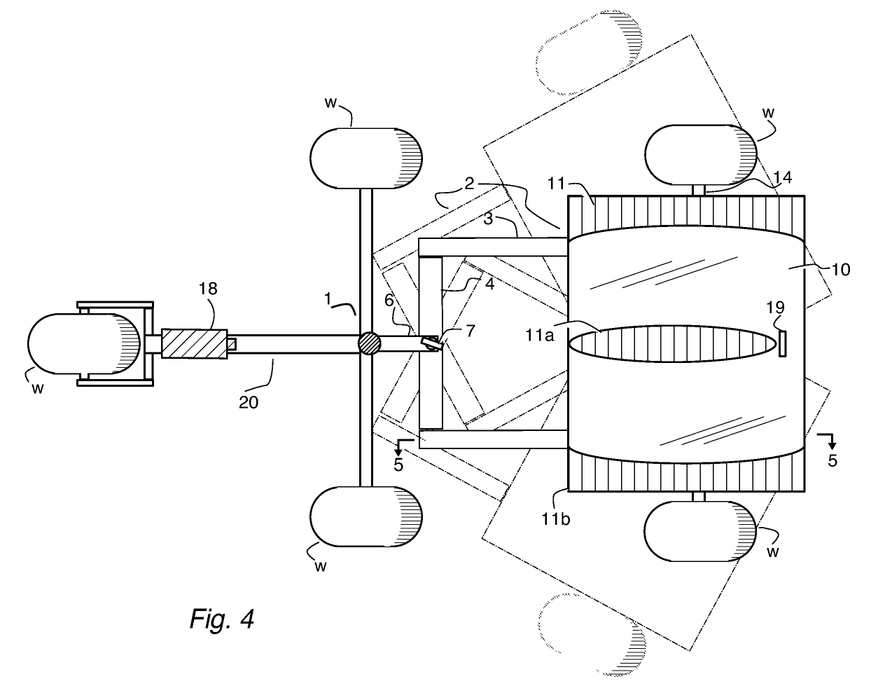

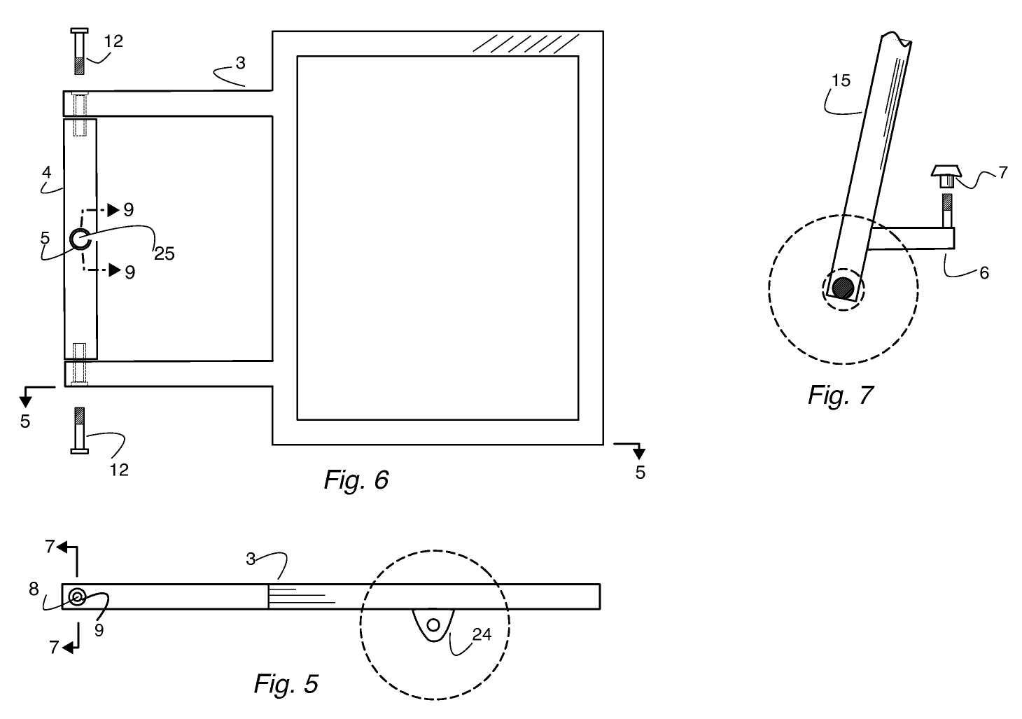

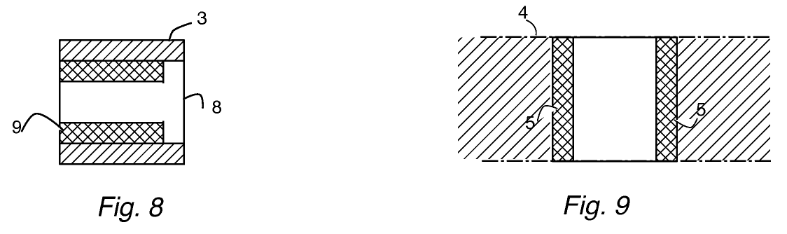

FIG. 3 provides an overview of the vehicle with the electric cart 1 connected to the platform 2.

The wheeled platform 2 is an assembly that include a carrying axle 14 that support an alloy frame 3 with two arms pivotally connected to the front section 4 with bolts 12. The holes 8 in the arms, trough which the bolts 12 will be hinged to the section 4, are folded with Teflon rings 9 (or bearing) The front section 4 of the frame 3 is locked by the hook 6 to the electric cart (FIG. 3 and FIG. 7) trough the hole 25 in its midsection. Hole 25 is folded with a Teflon ring 5 (or a bearing) to ensure a smooth and noiseless rotation (FIG. 9).

Over the square portion of the frame is placed (glued) a plastic board 10 (or equivalent light yet rigid material) with no skid surface and on top are placed 3 rubber shapes 11 (left 11a, center 11 and right 11) to hold the rider's feet during eventual sideslip of the chariot. The board will have an hole 19 in the back to allow the platform to be locked to the steering column with a soft hook 16 when lifted up.

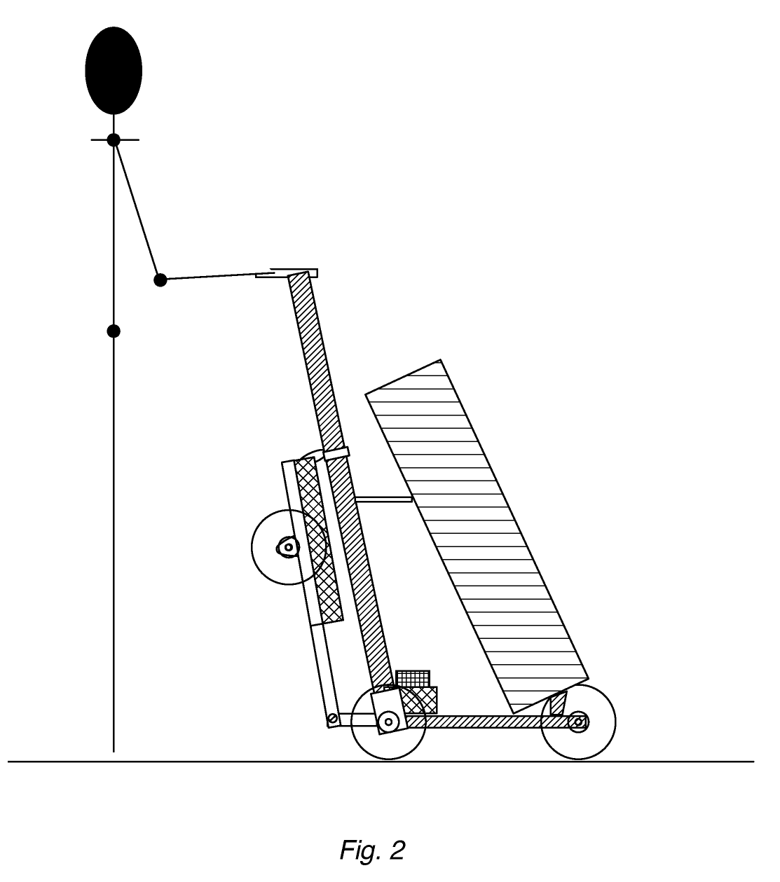

The platform 2 is free to rotate on the ground plane, around the hook 6, thus allowing the vehicle to steer and also pivot on the vertical plane to shift from an operational to a rest position since the front arms of the frame 3 are pivotally connected (bolt 12) to the front section 4 that is looked by the hook 6 to the electric cart (FIG. 2 and FIG. 3).

The wheels of the chariot (electric cart and wheeled platform) should have wide low pressure pneumatic tires with low profile turf tread to allow traction over grass and slopes, but smooth and large enough not to damage the fairways.

The electric cart 1, in order to drawn the platform and to ensure the proper level of drivability needs to complain with the following specifications:

Double electric engines:

A) This is required to provide the power to carry a weight of at least 120 kg over hills (even if this can be achieved also with a single powerful engine).

B) The two engines, one for each wheel of the cart, is key to allow an effortless maneuverability of the chariot, steering by varying the power applied to each wheel; if you have to steer manually it may require a significant effort.

Utilization Selector mode positions: Ride-Walk-Stop.

The electric cart will be equipped with security sensors on the handle bar. When enabled in the Ride mode, the sensors will stop the engines if the rider leaves the handle bar, thus preventing the vehicle from moving in case of accidental fall of the driver. In Walk mode the sensor will not be active and the rider can leave the platform down or lift it and control the cart either manually or via remote.

### SUMMARY OF ELECTRIC CART REQUIREMENTS

Steering Column:

Steering column bent, ideally, at 12°-15°

Steering column with adjusting height. This is needed to allow a comfortable position for the riders (for a rider of 175 cm height, the handle bar should be at 100 cm from the board)

Handle bar that allow both hand holding (this is not usual in the commercial electric cart)

Hook 6 at the bottom of the steering column as described above

A soft hook 16 must also be attached to secure the platform when lifted in resting position.

Engine

Two electric independent engines on the rear wheels. (this is a feature already available in commercial cart), this is key to allow the cart to steer with no effort.

Requested power must be greater than 350 w in order to carry the rider and golf bag.

Controls (to be added to a conventional electric cart)

Utilization Mode Selector: Ride/Walk/Stop

Security sensor on the handle bar. These are requested to cut the engine in case the driver falls off. This function will be active only in Ride Mode.

1. The combination of an electric golf cart with a wheeled platform that allow a golfer to ride on top of the platform leveraging the propulsion capability of the electric cart.

2. The rear wheeled platform can be lifted to an upright position allowing the golfer to walk behind the golf cart in a standard fashion, This is also functional to store the golf chariot with no additional room requirement than a standard electric golf cart.

3. The Golf chariot by design can be easily disassembled to be eventually carried with a car.
